(19) United States
(12) Patent Application Publication
(10) Pub. No.: US 2019/0028487 A1
(43) Pub. Date: Jan. 24, 2019

(54) Indirect Authorization Transport

(71) Applicants: Kai Romer, Unterfohring (DE); Philipp Spangenberg, Munchen (DE)

(72) Inventors: Kai Romer, Unterfohring (DE); Philipp Spangenberg, Munchen (DE)

(21) Appl. No.: 15/755,694

(22) PCT Filed: Jul. 27, 2016
(86) PCT No.: PCT/EP2016/067909

§ 371 Date: Mar. 19, 2018

(30) Foreign Application Priority Data
Aug. 31, 2015 (DE) 10 2015 216 630.9

(51) Int. Cl. H04L 29/06; H04W 12/10; H04W 12/06

(52) U.S. Cl. CPC H04L 63/123; H04L 63/0823; H04W 12/06; H04W 12/10; H04L 63/126

(57) ABSTRACT

The present invention relates to methods and systems for transmitting at least one authorization for a control function of a technical system. In one embodiment, the method comprises receiving the at least one authorization via an unsecured communication channel (200, 300) at a verification unit (35) of an object (30) to be protected, wherein the at least one authorization is cryptographically signed by a trustworthy entity (10).

### 1. TECHNICAL FIELD

The present invention relates to methods and systems for securely transmitting authorizations for control functions of a technical system, such as a vehicle. In preferred embodiments, the security of smart cards is combined with the advantages of internet enabled smartphones, so that an authorization for an object to be protected can be transmitted via an unsecure channel but nevertheless still be used securely and reliably.

### 2. TECHNICAL BACKGROUND

From the prior art identification and locking systems for the organization of access and usage rights in connection with technical systems are known. For example, the applicant's European patent 1 910 134 B1 relates to an identification system for the authorization-dependent use of a technical system. By such a system, control functions of a vehicle can be triggered, for example, by means of a cell phone or smartphone, such that the vehicle can for example be opened and/or started with the cell phone or smartphone. Cell phones or comparable electronic devices (e.g. smartphones, personal digital assistants (PDAs) and/or tablet computers) can be flexibly provided with appropriate authorizations due to their internet connectivity, provided they are connected via a secure connection to the entity that issues the authorizations. However, this only works if an internet connection actually exists, which is not always the case in applications such as car rental, for example when the vehicle is situated an underground car park.

Other identification and locking systems known from the prior art use devices called smart cards as a “key” on which appropriate authorizations can be stored instead of cell phones or other electronic terminals. In such systems, however, it has until now been considered necessary to locally write the authorizations onto the smartcard by a trustworthy entity (e.g. the car rental company), which is inflexible and labor intensive.

Therefore, it is an object of the present invention to provide methods and systems with which authorization carrier, such as smart cards, can be securely and flexibly equipped with authorizations, such that the disadvantages mentioned above in connection with the prior art are at least partially overcome.

### 3. SUMMARY OF THE INVENTION

This problem is solved according to one aspect of the invention by a method for transmitting at least one authorization for a control function of a technical system. In the embodiment according to claim 1, the at least one authorization is received via an unsecured communication channel at a verification unit of an object to be protected. According to the invention, the at least one authorization is cryptographically signed by a trustworthy entity.

Because the at least one authorization is cryptographically signed by a trustworthy entity (also called “trust center”) and preferably is also issued by it, the authorization can be transmitted via an unsecure or unsecured channel and nevertheless can be used securely and reliably. An unsecured channel is a communication between two units via at least one interface, in which it cannot be ensured on the transmission path that a data packet can be read out or changed by unauthorized persons. Such an unsecure channel may be, for example, the internet, a SMS, a QR code, GSM, BTLE, Zigbee, general radio links such as e.g. 866 MHz, a transport channel via an authorization carrier, or the like. Due to the, preferably digital, signature, the trust center secures the scope and content of the authorization cryptographically, which can be verified by the recipient. A digital signature is understood to mean an asymmetrical cryptosystem in which a sender uses a secret signature key (the private key) to compute a value for a digital message (in this case the at least one authorization), which is also called a digital signature. This value allows anyone to verify the undeniable authorship and integrity of the message (here the at least one authorization) using the public verification key (the public key). As a signature method, for example, those based on prime factor decomposition, e.g. RSA, those based on discrete logarithms, e.g. El Gamal, DSA, those based on elliptic curves, e.g. ECDSA, or the like may be used.

In accordance with one aspect of the present invention, the at least one authorization may be received via an unsecured communication channel from an authorization transport carrier. The authorization transport carrier may have previously received the at least one authorization from the trustworthy entity. This makes it possible to transmit, for example, the at least one authorization from the trustworthy entity (the trust center) to a smartphone (which in this example is the authorization transport carrier) and then from the smartphone to the verification unit (which may be located, for example, in a vehicle as an object to be protected). This way, the flexibility of the method is considerably increased, since any conventional electronic devices, such as smartphones, can be used as a transport medium for the at least one authorization. At the same time, the authenticity of the transmitted at least one authorization is preserved thanks to the signature described above, although the at least one authorization is transmitted via an unsecured channel (for example the internet enabled smartphone). It is to be understood that instead of a smartphone any other type of authorization carrier may be used (further examples below) and that the term “transport” authorization carrier is merely intended to clarify that the authorization carrier is used as the means of transport for the at least one authorization; however, this does not exclude that the authorization carrier is not itself able to actively use authorizations.

Alternatively or additionally, the at least one authorization can be received by the trustworthy entity via an unsecured communication channel. For example, it is conceivable that the verification unit (for example in the vehicle) picks up the at least one authorization directly, e.g. via an internet connection, from the trust center.

Preferably, the at least one authorization is also transmitted from the verification unit to an authorization destination carrier via a second, preferably unsecured, communication channel. This way, it possible for the at least one authorization which the verification unit may have received from the authorization transport carrier as explained above, e.g. a smartphone, is transmitted to another authorization carrier, such as a smart card. This aspect of the invention takes into account the demand of some automobile manufacturers, according to which a smartphone may be used to unlock the vehicle doors, but not for starting the vehicle, which is in this example done by means of the authorization on the smart card. In this aspect, i.e. the transmission of at least one authorization to any authorization carrier via an unsecured communication channel, the significant increase in flexibility of the method according to the invention manifests, which still satisfies the highest security standards due to the signature of at least one authorization.

The present invention also enables a direct transmission of at least one authorization from an authorization transport carrier to an authorization destination carrier. For this purpose, a method for transmitting at least one authorization for a control function of a technical system is provided, in which the at least one authorization is received by an authorization transport carrier via a third, preferably unsecured, communication channel at an authorization destination carrier. In order to guarantee the authenticity of the at least one authorization, it is also cryptographically signed by a trustworthy entity.

As already explained above, the at least one authorization at the authorization transport carrier may be received by the trustworthy entity via a, preferably unsecured, fourth communication channel. Furthermore, as has likewise been described above, it is possible for the at least one authorization to be verified for authenticity and origin in the trustworthy entity, which is preferably carried out by the verification unit of the object to be protected.

Furthermore, the method may comprise the further step of authenticating the authorization destination carrier against the verification unit. Thus, the authorization destination carrier (e.g. a smartcard) can unambiguously prove its identity to the verification unit. The authorization transport carrier may also comprise an authentication unit in order to authenticate itself against the verification unit. Therein, the authorization transport carrier may comprise a less strong authentication unit than the authorization destination carrier.

The at least one authorization is preferably assigned to one or multiple authorization carriers, for example at least to the authorization destination carrier. This way, certain authorization destination carriers may be provided with authorizations for certain control functions (e.g. deactivating the vehicle immobilizer, unlocking a vehicle, locking a vehicle, enabling full vehicle performance, starting a booking, ending a booking, enabling additional features such as navigation or seat heating, or the like).

The authorization carriers mentioned herein, i.e. the authorization transport carrier and/or the authorization destination carrier may be an internet enabled authorization carrier, a cell phone, a smartphone, a PDA, a tablet computer, a smart watch, a smartcard, an NFC card, a smart token, a vehicle key, an RFID card and/or a SIM card.

The at least one authorization is preferably a certificate, particularly preferably a digital certificate, for example a public-key certificate according to the X.509 standard, or another proprietary certificate system. The at least one authorization may comprise one or more of the following limitations: a time limitation, a functional limitation, a channel limitation, a limitation to one or more authorization carriers and/or authorization carrier groups, a limitation to one or more objects to be protected, a local limitation and/or a person-related limitation.

In another aspect of the present invention, one or more authorization transport carrier (20) may be used to transmit the authorization (or also multiple authorizations) to a destination (i.e. preferably an authorization destination carrier (40) or a verification unit (35)) until the destination acknowledges said transmitting to the sender (10) (i.e. preferably a trustworthy entity). This way, the sender, i.e. in general the trust center, will be informed that the authorization has arrived at the destination, even if the authorization needs to pass through a chain of authorization carriers. It is to be understood that other aspects of the present invention may provide such a chain of authorization carriers without the confirmation mentioned above.

The present invention further relates to a computer program comprising instructions for implementing one of the methods explained above.

In addition, a system is provided for transmitting at least one authorization for a control function of a technical system, wherein the system comprises a verification unit of an object to be protected, wherein the verification unit is adapted to receive the at least one authorization over an unsecured communication channel, wherein the at least one authorization is cryptographically signed by a trustworthy entity. Further, a system is provided for transmitting at least one authorization for a control function of a technical system, wherein the system comprises an authorization destination carrier adapted to receive the at least one authorization via a third communication channel from an authorization transport carrier, wherein the at least one authorization is cryptographically signed by a trustworthy entity. Furthermore, embodiments of the above-explained systems may be adapted to perform all or at least some of the methods explained above. Further advantageous embodiments of the systems according to the invention are specified in the dependent claims.

### 4. FIGURES

In the following the invention will be described in more detail with reference to the accompanying figures. It is shown:

FIG. 1: A schematic block diagram illustrating the interaction of various components according to embodiments of the invention; and

FIG. 2: An exemplary authorization in XML format according to embodiments of the invention (so-called “BlueID Ticket”).

### 5. DESCRIPTION OF PREFERRED EMBODIMENTS

Preferred embodiments of the present invention provide computer-implemented methods and systems that combine the security of smart cards with the benefits of internet enabled smartphones. Therein, at least one authorization for an object to be protected can be transmitted to an authorization carrier via an unsecure channel and nevertheless be used securely and reliably. Hereinafter, for the sake of simplicity, the term “authorization” will be used both in the singular and in the plural, but it should be understood that the present invention is applicable to any number of permissions.

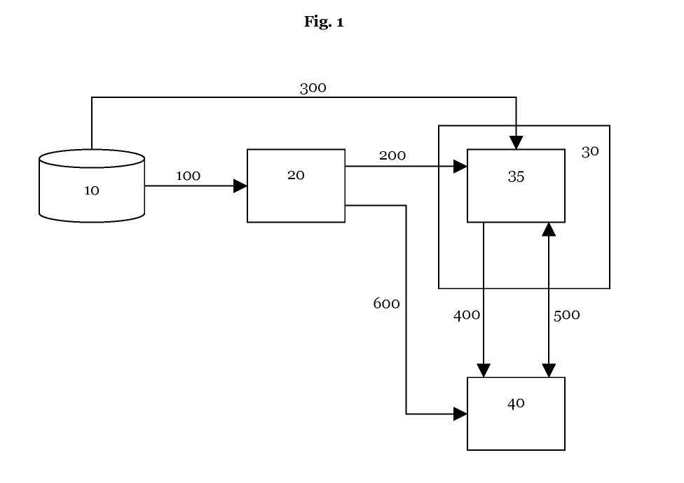

According to the embodiment, systems according to the invention comprise at least a subset of the components explained below with reference to FIG. 1:
A trustworthy entity to (also called “trust center”) which is suitable for creating and signing one or more authorizations.

A trust center generally is a service that all parties trust and that is able to issue and then sign authorizations. It takes care that only the authorized person can issue authorizations and that the secrets necessary for issuing the authorization are safely stored and used. Ideally, but not necessarily, a trust center is connected to the internet so that permissions can be easily and quickly distributed. However, as this poses a security risk, the trust center should preferably have multiple layers in order to achieve better protection and, if necessary, better mitigation during attacks. Typically, the outermost layer has the task of repelling attacks and protecting the inner layer(s). A second layer is typically responsible for managing and issuing authorizations and/or verifying permission to create authorizations. A third layer typically handles the signing of authorizations. Optimally, a fourth layer is provided for the secure storage of the cryptographic secrets. For this purpose, a so-called hardware secure element is often used, which, however, can also be integrated into the third layer.

A trust center can be arranged at different places in the overall system. Ideally, the site is protected against unauthorized access (both digital and physical), is monitored to detect tampering, and has high availability for retrieving created authorizations. In most cases, this will be the case in a particular area of a data center. However, it is also often chosen a location in the workspace of the security guard. Thus, the security level is low.

For example, a trust center may be operated as a cloud service for a plurality of users by a trusted entity, such as the applicant's firm, or locally by the IT department of the respective company.
At least one object to be protected 30 (also called “secured object”), which is managed by the authorization system according to the invention.

These may be, for example, vehicles (e.g. motor vehicles, trucks, commercial vehicles), electrical and/or electronic machines (e.g. car washes, elevators), locks (e.g. electronic cylinder lock, electronic fittings, electronic door opener), barriers and/or gates, sliding doors and/or revolving doors, or the like.
One or more authorizations, which are preferably assigned to one or more defined authorization carriers. For example, an authorization may be defined in XML format.

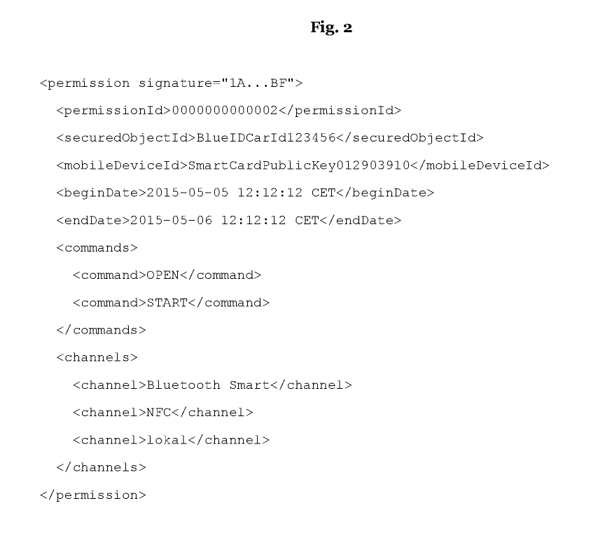

In the embodiment of FIG. 2, for example, the signature that is stored in the field permission->signature, is formed over all user data between the permission tags. Thus, a verification unit can verify the authenticity.
One or more authorization carriers 20, 40 which are adapted for storing one or more (signed) authorizations. An authorization carrier 20, 40 may comprise an authentication unit capable of cryptographically authenticating itself against the verification unit 35 (see below). Such an authorization carrier 20, 40 is therefore suitable for the transport and storage or use of at least one authorization (e.g. a smartcard or a smartphone). Authorization carriers 20, 40 without an authentication unit cannot authenticate themselves and thus do not represent full-fledged keys; they serve only to transport at least one authorization (for example a USB stick).
A verification unit 35 in the object 30 to be protected (or connected to the object 30 to be protected) which is adapted for verifying whether the at least one authorization is correct and unchanged and that the authorization originates from the trust center 10 and/or whether the authorization carrier 20, 40 is the one he claims to be (authentication).
The verification unit preferably is a closed system that is protected against manipulation. It may comprise a processor that is adapted for controlling the communication with the authorization carrier and/or for carrying out the verification of the authorization. In a vehicle this is often the BCM (Body Control Module). In particularly small and power consumption oriented implementations, such as electronic lock cylinders, this is often executed directly in the communication unit, e.g. the BluetoothLE chip.

A particular advantage of the present invention is that an authorization carrier 40 not being connected to the internet can be authorized to execute, initiate or trigger a control function of a technical system 30, without the at least one authorization having to be picked up by the authorization carrier 40 at the trust center 10. This is achieved by separating authorization and authentication. By means of a digital signature, the trust center 10 secures the scope and content of the authorization cryptographically, that is, which authorization carrier 40 is allowed what to do. At the time of creation of the authorization, the identity of the authorization destination carrier 40 needs to be known to the trust center 10.

After the creation of the authorization in the trust center 10, by means of the methods and systems according to the invention, the authorization may not only be downloaded directly from the trust center 10 to the authorization carrier 40, but may also further be transmitted to the authorization destination carrier 40 via any unsecured channel (for example via another authorization carrier 20, a so-called “authorization transport carrier”). Nevertheless, the authorization on the authorization destination carrier 40 can be used securely and reliably.

To provide an authorization destination carrier 40 with one or more authorization, the present invention contemplates various exemplary embodiments:

### Example 1

1. The trust center 10 transmits the authorization via the channel 100 (e.g. internet, SMS, QR code, GSM, online connected card reader/writer, or other unsecure channel as mentioned above) to the authorization transport carrier 20 (e.g. a smartphone). Optionally, the authorization transport carrier 20 may also comprise one or more authorizations for the object 30 to be secured and/or use the transferred authorization.
2. The authorization transport carrier 20 preferably transmits the authorization via the channel boo directly (for example, preferably via NFC, depending on the authorization carrier (e.g. BLE key fob) but also via Bluetooth classic (BT 1.0-3.0) or Bluetooth LE/Smart) to the authorization destination carrier 40 (e.g. a smartcard).

Therein, it is particularly advantageous that the authorization can be transmitted via an unsecure channel (for example smartphone) from the trust center 10 to the authorization destination carrier 40 (for example smartcard). In particular, no physical contact between authorization target carrier 20 and trust center 10 is necessary.

However, this embodiment may be limited by restrictions of the authorization transport carrier 20 (for example, not all currently available smartphones allow for a direct communication link with a smart card).

### Example 2

1. The trust center 10 transmits the authorization via the channel too (e.g. internet, SMS, QR code, GSM, online connected card reader/writer, or other unsecure channel as mentioned above) to the authorization transport carrier 20 (e.g. a smartphone). Optionally, the authorization transport carrier 20 may also comprise one or more authorizations for the object 30 to be secured and/or use the transferred authorization.
2. The authorization transport carrier 20 transmits the authorization via the channel 200 (for example, preferably Bluetooth LE or classic, NFC, Zigbee, general radio links such as 866 MHz, or another unsecure channel as mentioned above) to the verification unit 35 of the object 30 to be protected (e.g. a vehicle).
3. The verification unit 35 transmits the authorization via the channel 400 (e.g. preferably NFC, depending on the authorization carrier (e.g. BLE Key Fob) but also via Bluetooth classic (BT 1.0-3.0) or Bluetooth LE/Smart) to the authorization destination carrier 40 (e.g. a smart card), preferably as soon as the carrier communicates with the verification unit 35.

Again, the authorization may be transmitted via an unsecure channel (e.g. smartphone) from the trust center 10 to the authorization destination carrier 40 (e.g. smart card). Subsequently, the verification unit 35 may be adapted to delete the authorization from its memory. This may be particularly advantageous in the context of car rental companies, where the verification unit of a given vehicle is loaded in a short time with a plurality of authorizations (for the different customers), which could lead to memory bottlenecks. Further, some automobile manufacturers demand that an authorization may never be allowed to remain in the vehicle, which is also addressed by this embodiment.

### Example 3

1. The verification unit 35 of the object 30 to be protected preferably downloads the authorization via the channel 300 directly from the trust center 10 (e.g. via the Internet, general radio links such as 866 MHz, SMS, GSM, or other unsecure channel as mentioned above).
2. The verification unit 35 transmits the authorization via the channel 400 (e.g. preferably NFC, depending on the authorization carrier (e.g. BLE Key Fob) but also via Bluetooth classic (BT 1.0-3.0) or Bluetooth LE/Smart) to the authorization destination carrier 40 (e.g. smart card), preferably as soon as the authorization destination carrier communicates with the verification unit 35.

Therein, it is particularly advantageous that the authorization can reach the authorization carrier without time-consuming detours, since the verification unit is preferably connected directly to the internet. In addition, the delivery of an authorization can be easily retraced. A possible disadvantage here is that an online connection is necessary. If for example in an underground car park no internet connection is present at e.g. a vehicle, no new authorization can be loaded onto it. In this case, an alternative channel needs to be used then, since the vehicle cannot move outside of the underground car park without an authorization.

Once the authorization has been transmitted to the authorization destination carrier 40, it can be used accordingly. In order to check whether an authorization holder is authorized to perform an action, two steps are carried out according to preferred embodiments:
1. The authorization is loaded by the verification unit (e.g., from a local memory or from the authorization carrier) and is verified by the verification unit. Therein, it is preferable to first create a hash over the content and then to verify the signature by means of the public key of the issuing trust center. Now the content is analyzed. If the authorization for the verification unit is determined and the further limitations apply, the identity of the associated authorization carrier is read out of the authorization.
2. Then the identity of the authorization carrier can be verified. For this purpose, it is preferably checked whether there is a specific secret in the authorization carrier. The necessary verification data can be derived from the identity description of the authorization carrier. Usually, a random number is sent to the authorization carrier and its response is cryptographically verified via the public key of the authorization carrier from the authorization. If the authorization carrier matches the authorization, the action is performed or enabled.

Furthermore, the present invention also allows for embodiments in which the authorization remains on the verification unit 35, i.e. the authorization is not transmitted to the authorization destination carrier 40. The corresponding processes are:

### Example 4

1. The trust center 10 transmits the authorization over the channel too (e.g. internet, internet, common radio links such as 866 MHz, SMS, GSM, or other unsecure channel as mentioned above) to the authorization transport carrier 20 (e.g. a smartphone). Optionally, the authorization transport carrier 20 may also comprise one or more authorizations for the object 30 to be secured and/or use the transferred authorization.
2. The authorization transport carrier 20 transmits the authorization via the channel 200 (e.g. preferably NFC, depending on the authorization carrier (e.g. BLE Key Fob) but also via Bluetooth classic (BT 1.0-3.0) or Bluetooth LE/Smart) to the verification unit 35 of the object 30 to be secured (e.g. a vehicle).

### Example 5

1. The verification unit 35 of the object 30 to be protected preferably downloads the authorization via the channel 300 directly from the trust center 10 (e.g., via internet, general radio links such as 866 MHz, SMS, GSM, or other unsecure channel as mentioned above).

As a result, particularly fast verification times can be achieved (see the arrow 500 in FIG. 1), since the authorization does not have to be transmitted to the authorization destination carrier 40. In addition, a pre-verification of the authorization may take place. Thus, the permission does not need to be checked at the time of execution, but may already considered being secure.

In all illustrated embodiments, the authorization carrier 40 and/or the verification unit 35 need preferably to be made known to the trust center 10 in order to enable the authentication. This preferably takes place prior the creation of the at least one authorization by the trust center. The process of making known may comprise the following:
1. The verification unit receives the public key of the trust center, which it should trust, before start of use. This usually happens during production or during putting into use by means of a configuration tool.
2. The identity of the authorization carriers and the identifier of the verification unit need to be available to the trust center at the latest when creating an authorization, so that these can be entered into the authorization.

All embodiments described herein have in common that the authorizations are signed by the trust center 10 and can be verified by the verification unit 35 for authenticity and origin in the trust center 10, so that the authorizations can also be distributed via unsecured or unsecure channels.

Within the scope of the present invention, among others, the following authorization carriers 20, 40 may be used:
Internet connected devices or internet connected devices that are temporarily connected to the internet:
   Smartphone
   Cell phones with the possibility to load application programs (so-called “apps”)
   Smart watch
Offline devices or devices with asynchronous connection without direct internet connection:
   NFC card, e.g. smart card
   Smart token, e.g. car key, building key, access card, etc.
   RFID card
   SIM card
   Smart watch

The at least one authorization discussed herein may comprise one or more of the following components:
Time limitation, e.g. validity period
Functional limitation, e.g. only function “open”
Channel bonding, e.g. only NFC
Limitation to one or more authorization carriers or authorization carrier group
Limitation to one or more objects to be protected
Local limitation, e.g. only in Munich or within a radius of x meters of a certain location
Limitation to persons, groups of persons and/or user roles

An illustrative application example is explained below, which is intended to illustrate the advantages of the present invention:

In a car rental, each user has a personal customer card, namely a smart card 40, which is uniquely assigned to the user. The user books a car directly with his smartphone 20. Shortly before the start of the booking, the user receives on the one hand the time-appropriate digital authorization and the position of the vehicle 30 on his smartphone 20. The user goes to the vehicle 30, which is located in the underground car park of the car rental, and opens the vehicle with the smartphone 20, e.g. by means of the data channel BLE (“Bluetooth Low Energy”) or respectively by means of one of the methods described in the European patents EP 1 910 134 B1, EP 2 564 583 B1 and EP 2 193 607 B1 of the applicant and sits into the vehicle. To increase security, starting the vehicle 30 may only be done by means of the personal smartcard 40. Therefore, during the opening process, the authorization for starting the vehicle 30 was transmitted from the smartphone 20 to its verification unit 35, wherein the authorization is assigned to the smart card 40. The user places the smart card 40 on a reader 35 in the vehicle 30 and the authorization is transferred to the smart card 40. Then, the smart card 40 may be authenticated by the vehicle 30 or respectively of the verification unit 35 and the authorization may be verified. Subsequently, the vehicle 30 may be started.

Further, the smart card 40 may also execute the localization (Thatchem) and/or certification (e.g. CC EAL 5+). The use of a smart card from a well recognized manufacturer such as e.g. G & D also has the advantage that these cards can be purchased in one version on the market that meets the highest requirements for the identity carrier. This may be e.g. a certification according to a Common Criteria (e.g. EAL 5+). A smart card using NFC as a communication channel also solves the problem of identifying the authorization carrier in the vehicle as these can only be read in a reader that has a reading area limited to a few centimeters.

### LIST OF REFERENCE NUMERALS

10 Trustworthy entity (“TrustCenter”)
20 Authorization transport carrier
30 Object to be protected
35 Verification unit
40 Authorization destination carrier
100 Transmission of the authorization from the trust center 10 the authorization transport carrier
200 Transmission of the authorization from the authorization transport carrier to the verification unit
300 Transmission of the authorization from the trust center 10 the verification unit
400 Transmission of the authorization from the verification unit to the destination authorization carrier
500 Authentication of the authorization target carrier
600 Transmission of the authorization from the authorization transport carrier to the authorization destination carrier

1-21. (canceled)

22. A method for transmitting at least one authorization for a control function of a system, the method comprising:
a. receiving the at least one authorization via an unsecured communication channel at a verification unit of an object to be protected;
b. wherein the at least one authorization is cryptographically signed by a trustworthy entity.

23. The method of claim 22, wherein the at least one authorization is received from an authorization transport carrier over an unsecured communication channel.

24. The method 23, wherein the authorization transport carrier comprises an authentication unit to be able to authenticate itself against the verification unit.

25. The method of claim 24, wherein the authorization transport carrier comprises a less strong authentication unit than the authorization destination carrier.

26. The method of claim 22, wherein the at least one authorization is received from the trustworthy entity over the unsecured communication channel.

27. The method of claim 22, further comprising:
verifying the at least one authorization for its authenticity and its origin in the trustworthy entity.

28. The method of claim 22, further comprising:
transmitting the at least one authorization from the verification unit to an authorization destination carrier via a second communication channel.

29. The method of claim 22, wherein the at least one authorization is assigned to one authorization carrier or multiple authorization carriers.

30. The method of claim 22, wherein the authorization transport carrier and/or the authorization destination carrier is an Internet-enabled authorization carrier, a cell phone, a smartphone, a tablet computer, a smart watch, a smartcard, a NFC Card, a smart token, a vehicle key, a RFID card and/or a SIM card.

31. The method of claim 22, wherein the at least one authentication is a certificate.

32. The method of claim 22, wherein the at least one authorization comprises one or more of the following limitations: a time limitation, a functional limitation, a channel limitation, a limitation to one or more authorization carriers and/or authorization carrier groups, a limitation to one or more objects to be protected, a local limitation and/or a person-related limitation.

33. The method of claim 22, wherein one or more authorization transport carriers are used to transmit the authorization to an authorization destination carrier or a verification unit, until the authorization destination carrier or the verification unit acknowledges said transmitting to the sender.

34. The method of claim 22, further comprising:
receiving the at least one authorization via a third communication channel at an authorization destination carrier from an authorization transport carrier;
wherein the at least one authorization is cryptographically signed by a trustworthy entity.

35. The method of claim 34, further comprising:
receiving the at least one authorization at the authorization transport carrier from the trustworthy entity via a fourth communication channel.

36. The method of claim 28, further comprising:
authenticating the authentication destination carrier against the verification unit in the verification unit.

37. A system for transmitting at least one authorization for a control function of a technical system, the system comprising:
a. a verification unit of an object to be protected, wherein the verification unit is adapted to receive the at least one authorization over an unsecured communication channel;
b. wherein the at least one authorization is cryptographically signed by a trustworthy entity.

38. The system of claim 37, further comprising:
an authorization transport carrier adapted to send the at least one authorization via the unsecured communication channel to the verification unit.

39. The system of claim 37, further comprising:
the trustworthy entity adapted to send the at least one authorization over the unsecured communication channel to the verification unit.

40. The system of claim 37, further comprising:
an authorization destination carrier adapted to receive the at least one authorization from the verification unit via a second communication channel.

41. The system of claim 37, further comprising:
an authorization destination carrier adapted to receive the at least one authorization via a third communication channel from an authorization transport carrier;
wherein the at least one authorization is cryptographically signed by a trustworthy entity.

42. A non-transitory computer accessible memory medium storing program instructions for transmitting at least one authorization for a control function of a system, wherein the program instructions are executable by one or more processors to:
receive the at least one authorization via an unsecured communication channel at a verification unit of an object to be protected;
wherein the at least one authorization is cryptographically signed by a trustworthy entity.
